(19) United States
(12) Patent Application Publication
(10) Pub. No.: US 2026/0134223 A1
(43) Pub. Date: May 14, 2026

(54) DYNAMIC EXPANSION OF TEXT TO DATA SOURCE QUERY USING LEARNED CONTEXT

(71) Applicant: International Business Machines Corporation, Armonk, NY (US)

(72) Inventors: Andrew R. Freed, Cary, NC (US); Luyuan Gao, Tampa, FL (US); Jasmeet Singh, Apex, NC (US); Jonathan Springer, West Melbourne, FL (US); Marvin Limpijankit, New York, NY (US)

(21) Appl. No.: 18/940,935

(22) Filed: Nov. 8, 2024

(51) Int. Cl. G06F 40/40

(52) U.S. Cl. CPC G06F 40/40

(57) ABSTRACT

Mechanisms are provided for enhancing artificial intelligence computer model response generation. The mechanisms receive an input request from a client computing device and identify first field(s) of a data dictionary of a data source schema for inclusion in an initial set of fields having direct matches to elements of the input request. The mechanisms, for each first field, analyze second fields, adjacent to the one or more first fields, in the data dictionary, to identify a set of relevant second fields which are added to the initial field listing to generate an expanded field listing. A prompt to a generative artificial intelligence (AI) computer model is generated comprising a context portion populated with data for the first fields and relevant second fields. The prompt is processed by the AI computer model to generate a response based on the context portion of the prompt.

### BACKGROUND

The present application relates generally to a data processing apparatus and method and more specifically to a computing tool and computing tool operations/functionality for enhancing artificial intelligence (AI) model query processing based on dynamic expansion of text to data source queries using learned context.

Generative AI refers to deep-learning computer models that can take raw data, e.g., all of the electronic documents from one or more websites, and learn to generate statistically probable outputs when prompted. At a high level, generative AI computer models encode a simplified representation of their training data and draw from it to create a new work that is similar, but not identical, to the original data. As a result, Generative AI can generate new high-quality text, images, and other content based on the data they are trained on.

Retrieval augmented generation (RAG) is a technique that assists Generative AI computer models with regard to their information retrieval capabilities. RAG may be used to modify interactions with a Generative AI computer model, such as a Large Language Model (LLM) or the like, so that the Generative AI computer model responds to a user query with reference to specific sets of documents, using this information to augment information drawn from its own vast, static training data. This allows the Generative AI computer model to use domain-specific and/or updated information.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises receiving an input request from a client computing device and identifying one or more first fields of a data dictionary of a data source schema for inclusion in an initial set of fields having direct matches to elements of the input request, to thereby generate an initial field listing. The method further comprises, for each first field in the initial field listing, analyzing second fields, adjacent to the one or more first fields, in the data dictionary, to identify a set of relevant second fields. In addition, the method comprises adding the set of relevant second fields to the initial field listing to generate an expanded field listing and generating a prompt to a generative artificial intelligence (AI) computer model comprising a context portion populated with data for the first fields and relevant second fields in the expanded field listing. Moreover, the method comprises submitting the prompt to the generative AI computer model for processing, wherein the generative AI computer model processes the prompt and generates a response to the input request based on the context portion of the prompt.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example diagram of the primary operational components of a dynamic expanded context prompt generation engine in accordance with one illustrative embodiment;

FIG. 3 is an example diagram illustrating an example of the data blocks used by a Large Language Model (LLM) to generate a response to an original input question in accordance with one illustrative embodiment; and

FIG. 4 is a flowchart outlining an example operation of generative artificial intelligence computer model based on an expanded context based prompt generated by a dynamic expanded contest prompt generation engine in accordance with one illustrative embodiment.

### DETAILED DESCRIPTION

The illustrative embodiments provide an improved computing tool and improved computing tool operations/functionality for enhancing artificial intelligence (AI) model query processing based on dynamic expansion of text to data source queries using learned context.

With the mechanisms of the illustrative embodiments, given a data schema, e.g., a database comprising 5000 columns of fields of data with hierarchical associations, a computing tool and computing tool operations/functionality are provide to identify the fields required to answer a received query, fetch them, and then pass them to a retrieval augmented generation (RAG) type of prompt for input to a generative AI computer model, which hereafter will be assumed to be a language model (LM) or large language model (LLM). The illustrative embodiments operate to identify the correct size context from a group of related fields in the large data schema, where this correct size context does not have too few fields comprising too few details, and does not have too many fields comprising too many details. That is, it has been found that LMs and LLMs may hallucinate if too few fields and too few details are provided upon which the LM/LLM operates. It has also been found that LMs/LLMs may not focus on the correct details if there are too many fields and too many details for the LMs/LLMs to process. Thus, a type of “Goldilocks” context needs to be identified to optimize the information upon which the LMs/LLMs operate to process a given input query.

It has been determined that the problems associated with LMs/LLMs and hallucinations, or failing to focus on the correct details to generate high quality responses to input queries, is further exacerbated by the fact that identifying the fields requested in the input query is not sufficient to respond to the query. That is, the fields in the query may require additional fields or context. Moreover, there are too many different kinds of input queries that may be submitted to the LM/LLM to store these additional fields and context in a system prompt, i.e., a static portion of the prompts used with the LM/LLM.

For example, consider a scenario in which a user inputs, to a LLM, a query of the type “Evaluated <company>'s ESG metrics”, and the LLM system has a data schema of a database with 5000 or more fields to consider (where the data schema is a blueprint that defines the structure, organization, and relationships of data in a database). Assume that the data schema has exactly 4 fields that exactly match the query, i.e., fields that specify ESG metrics, with these ESG metric fields specifying the ESG Ranking, Environmental Ranking, Social Ranking, and Governance Ranking of the specified <company>. In this case, as an example in which only exact matches to the query are used to determine the context for the operation of the LLM, the LLM may retrieve the context from the database as follows:

```
Context:
{“organization”:{
  “esgRanking”:{
    “score”:2,
    “environmentalRanking”: {“score”:1},
    “socialRanking”: {“score”:2},
    “governanceRanking”: {“score”:2}
    }
}}
```

The LLM, based on this context, and its previous training based on a large volume of training data, may generate a response for a specific company, where this response is of the type:

Their ESG ranking scores are as follows:
Overall ESG Ranking: The overall score is 2, which is a moderate ranking.
Environmental Ranking: The environmental score is 1, which is a low ranking. This suggests that <company> needs to improve its environmental practices significantly.
Social Ranking: The social score is 2, which is a moderate ranking.
Governance Ranking: The governance score is also 2, which is a moderate ranking.
   While the response to the query looks to be correct and is compact (approximately 70 words), a problem exists in that the rankings are interpreted incorrectly by the LLM. That is, the environmental score of 1 in this case is the best possible score for that metric, rather than a low ranking as indicated in the response. Thus, the LLM has incorrectly identified the environmental score to be a low ranking. This may negatively impact the response, and the user's understanding of the response, due to this inaccuracy. This is an example of an LLM having too few fields in the context upon which the LLM is to generate a response to a query.

If one attempts to expand the context upon which the LLM operates by using all the fields that are adjacent to these 4 fields, i.e., the exact matches to the query, the result is still not satisfactory as the context becomes too large for the LLM to focus on the most relevant information in the context. For example, there may be 100+ fields adjacent to the 4 exact match fields such that the context is the 100+ key value pairs in addition to the 4 exact match fields. The LLM generating the response is essentially reading these key-value pairs, which is far more than the 4 exact match fields. As an example, the response returned by the LLM may be nearly four times as large, e.g., around 250 words long, which means that the user would need to manually parse through this lengthy output to try to find relevant parts of the response. In such a case, there is a good likelihood that the response may be erroneous due to the LLM focusing on irrelevant or relatively less important portions of the context. This methodology also leads to inefficient and expensive runtimes for processing both the input and the output to the LLM due to the determination of the context, collection, and processing of the context as well as formulating the output. This is an example illustrating an LLM having too many fields in the context upon which the LLM is to generate a response to a query.

The illustrative embodiments provide an improved computing tool and improved computing tool operations/functionality that determines the most relevant portions of the data schema to include in the context, i.e., the most relevant adjacent data. That is, rather than taking all adjacent data to the directly matching fields for the input query/request, the illustrative embodiments provide automated computer intelligence to determine what other portions of the data schema are sufficiently relevant to the query/request and the directly matching fields so as to provide an expanded context that avoids the problems of too few data causing hallucinations while also avoiding the problems associated with contexts that are too large.

To identify the relevant fields to include in the context, the illustrative embodiments first determine initial fields required to answer an input query or provide a response to an input request, where these “required” fields are ones that are direct matches or are directly relevant to the query or request. The determination of initial fields, as well as the additional fields as discussed hereafter, are based on encodings of the textual data of the input query/request and these fields, e.g., the field name and field description. The determinations of initial fields and additional fields may involve similarity evaluations between such encodings. Any suitable text encoding process, e.g., using word encodings, that generates a vector of values representing the content of the input text may be used without departing from the spirit and scope of the present invention. Similarity evaluations may involve vector similarity computations, for example, where a vector similarity generates a similarity metric which may be compared to a predetermined criterion, e.g., a threshold similarity value, to determine if the vectors are sufficiently similar to one another.

The initial fields may be considered, in some illustrative embodiments, to be the direct matches, or directly relevant, to the criteria set forth in the input query/request and thus, and are the required fields for responding to the query/request. The direct matches may be determined using encoding models to encode the input query/request and the learned context to identify similar questions/requests by semantic search to output the fields required to answer those similar questions/requests. The direct match identification may also require the use of encoded data dictionaries to semantically search for the most relevant fields. The search of such encoded data dictionaries, and the computation of vector similarities, may be restricted to sub-sets of fields based on category and sub-category of the fields and their correlation with the category and sub-category of the encoded query/request. Search results from these two operations are consolidated to generate the initial field list. For example, a user asks “How long <company> has been in business?”. This query is encoded and semantically matched with a learned context such as “When was <company> established?”. Fields used to answer the learned context/similar questions, in this case, “organization startDate,” are then output as the initial field list. The category for “start date” and “established” is “company firmographics” and the sub-category is “operating details.”

Once the initial fields are determined and compiled into the initial field list, the illustrative embodiments dynamically augment this initial field listing based on a learned context. For example, in some illustrative embodiments, for each initial field F in the initial fields listing, its relevant sibling/cousin fields in the data schema are evaluated semantically, where sibling fields are those that have a same category and sub-category and cousin fields are those with the same category but different sub-categories. Thus, the search and/or evaluation of such sibling and cousin fields may be restricted to encodings of field names and descriptions of fields based on category and sub-category. Alternatively, or in addition, multiple searches for candidate fields to add to the initial field listing may be performed by appending search terms to the original query or request, where the terms added may be determined based on the terms of the directly matching, or directly relevant, fields. For example, with an initial query of the type “What is the ESG performance of <company>?”, subsequent searches may be performed with queries of the type “What is the ESG performance of <company> on date?”, “What is the ESG performance of <company> by ranking?”. “What is the ESG performance of <company> with methodology?”, and the like. That is, since the determination of a direct match field of “ESG score” is found when evaluating the original query, the mechanisms may look for additional fields that supply date/ranking/methodology information.

For example, stabilityIndexScore is a directly matching field to a query of the type “How risky is the <company>?”. In an example data dictionary of a data source schema, this field's relevant sibling/cousin fields include “stabilityIndexScore.scoreDate” and “stability IndexScore.scoreCommentary”, among others. Names and descriptions of these fields are encoded and semantically compared to the direct match field's name and description to determine their similarity. For each of these sibling/cousin fields, the illustrative embodiments determine a similarity with each of their corresponding initial fields in the initial field listing, e.g., determining a similarity between vector embeddings of the initial field name and description Fᵢ and the names/descriptions of the sibling/cousin fields, also referred to herein as candidate fields CFᵢ, where i is the index of the field in the initial field listing.

For example, for the “score” fields identified in the example mentioned above, i.e. the ESG Ranking, Environmental Ranking, Social Ranking, and Governance Ranking score fields, relevant sibling/cousin fields like ranking, percentile, description, reason, and the like may be identified, e.g., “ESG score” may have a “score percentile” with a description of “score percentile” being “how the company compares with its peers in ESG scoring”. As mentioned above, relevant sibling/cousin fields are identified through embeddings and vector similarity metric. For example, in one database schema, one of the directly matching fields, also sometimes referred to as “required” fields, to answer the user query of type “What is the ESG performance of <company>?” is “organization.esgRanking.score”, its relevant sibling/cousin fields are “organization.esgRanking.scoreDate” and “organization.esgRanking.peerPercentileGroup”. Another directly matching field is “organization.esgRanking.environmentalRanking.score”, and its relevant sibling/cousin fields include a field having the name “organization.esgRanking.environmentalRanking.scoreReasons.” For fields with numeric types, for example, “methodology” fields may be identified that indicate how the numeric value is obtained and/or what it represents, e.g., if the number is an actual or projected value, for example (numberOfEmployees.value and numberOfEmployees.reliabilityDescription). For some initial fields, sibling/cousin “date” fields may be identified that indicate when the data point was created or updated, for example as illustrated above. Thus, by scanning the sibling/cousin fields (candidate fields) CF; of an initial field Fi, and analyzing those fields to determine their similarity or relevance to the initial field Fi, the context for the processing of the input query/request may be expanded to include not only the initial fields Fᵢ, but the relevant candidate fields CFᵢ, which may be a subset of the candidate fields CFᵢ which is less than the total number of candidate fields CFᵢ.

The data for the expanded context comprising the initial fields Fᵢ and the subset of candidate fields CFᵢ may be input to a retrieval augmented generation (RAG) prompt engine which generates a RAG prompt for input to the LLM. The LLM then processes the RAG prompt comprising the expanded context determined by way of the above operations and generates a response to the input query/request in a manner generally known in the art. However, the response generated by the LLM will be more accurate and useable to the submitter of the input query/request because the mechanisms of the illustrative embodiments have expanded the context beyond just the required fields, i.e., the initial field listing, to include additional candidate fields that are determined to be relevant to the initial fields. This adds additional context, but does not add all of the possible candidate fields which would cause the problems associated with the naïve expansion example discussed above where all adjacent fields are added to the context. As a result, an improved operation of the LLM is accomplished that provides an efficient processing of input queries/responses that generates more accurate results with compact responses that do not require users to comb through large amounts of information in the response to find the relevant portions.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides improved computer functionality for identifying the “Goldilocks” zone for contexts in generating RAG prompts to LLMs for processing, i.e., contexts that are not too small to cause LLM hallucinations, and not tool large as to cause the LLM to not focus on the important aspects of the context and return voluminous responses that require users to comb through the responses to identify relevant information. The improved computing tool implements mechanism and functionality, such as a dynamic expanded context prompt generation engine, which cannot be practically performed by human beings either outside of, or with the assistance of, a technical environment, such as a mental process or the like. The improved computing tool provides a practical application of the methodology at least in that the improved computing tool is able to engineer the context of RAG prompts for LLMs that operate to optimize the response generation by the LLMs.

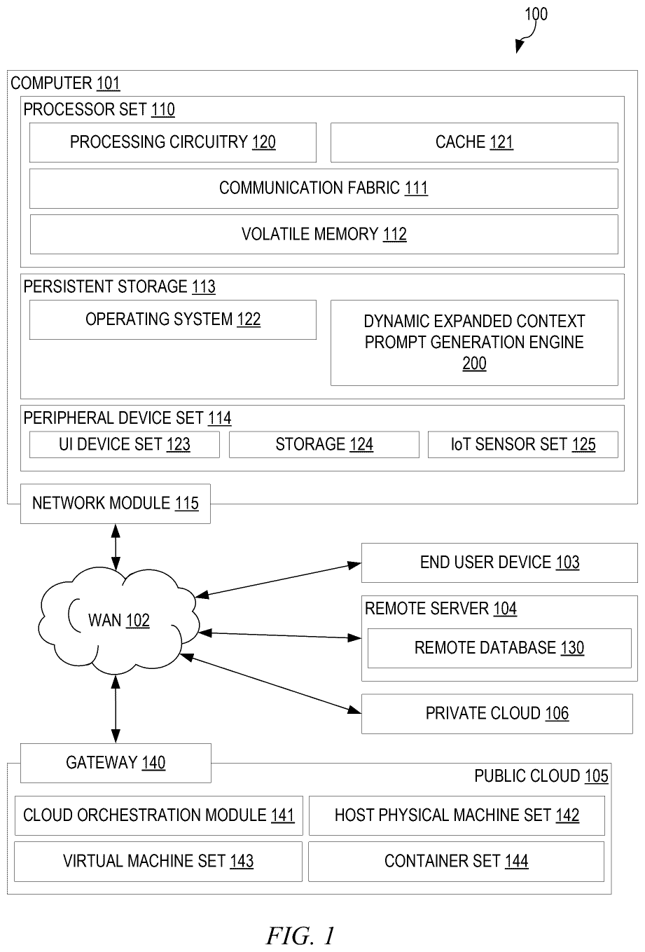

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as dynamic expanded context prompt generation engine 200. In addition to dynamic expanded context prompt generation engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and dynamic expanded context prompt generation engine 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in dynamic expanded context prompt generation engine 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in dynamic expanded context prompt generation engine 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a dynamic expanded context prompt generation engine 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates dynamic identification of expanded contexts for use in generating RAG prompts for LLMs.

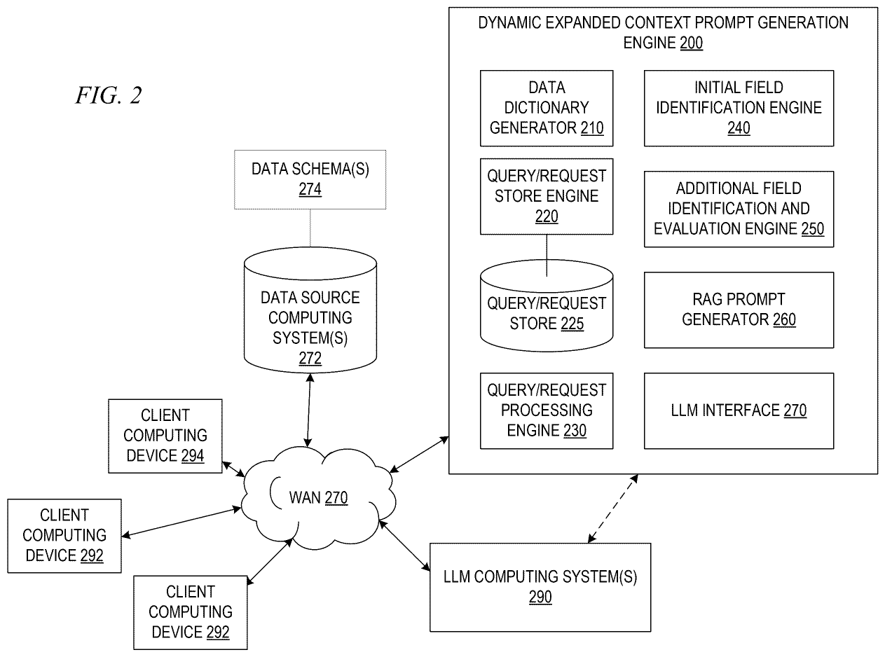

FIG. 2 is an example block diagram illustrating the primary operational components of a dynamic expanded context prompt generation engine in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that RAG prompts are generated for submission to LLMs so as to improve the performance of the LLM, which cannot be practically performed by human beings as a mental process and is not directed to organizing any human activity.

As shown in FIG. 2, the dynamic expanded context prompt generation engine 200 includes a data dictionary generator 210, a query/request store engine 220 and corresponding query/request store 225, a query/request processing engine 230, an initial field identification engine 240, an additional field identification and evaluation engine 250, a RAG prompt generator 260, and an LLM interface 270. The dynamic expanded context prompt generation engine 200 may operate based on data dictionaries generated for various data sources, such as database(s) 272, based on the data schema 274 of the data sources. These data dictionaries specify the fields and their relationships in the data sources, and provides information for identifying relevant fields for assisting generative AI computer models in performing their operations.

The dynamic expanded context prompt generation engine 200 operates in conjunction with one or more LLMs 290 and client computing devices 292-296 via one or more data networks 280. For example, client computing devices 292-296 may submit queries/requests directed to an LLM 290 which are intercepted or redirected to the dynamic expanded context prompt generation engine 200 for processing. The dynamic expanded context prompt generation engine 200 processes the intercepted or redirected query/response to generate an expanded context RAG prompt that is submitted to the LLM 290 which then responds to the client computing devices 292-296 with the LLM 290 generated response. It should be appreciated that while shown as separate elements in FIG. 2, in some illustrative embodiments, one or more of the components of the dynamic expanded context prompt generation engine 200 may be integrated with the LLM 290, be provided on the same data processing system as the LLM 290, or the like. Any architecture that facilitates the interactions between the dynamic expanded context prompt generation engine 200 and the LLM as described herein may be used without departing from the spirit and scope of the present invention.

The data dictionary generator 210, as an initial setup operation of the dynamic expanded context prompt generation engine 200 creates a data dictionary from a data source schema, e.g., a schema 274 of a database 272. In some illustrative embodiments, the data dictionary comprises fields such as category, sub-category, name, and description extracted from the data source schema. This process may be performed with regard to each data source schema for each possible data source 212-214 that the LLM 290 may use as a basis for performing its operations for processing queries/requests. Thus, a plurality of data dictionaries may be generated as part of this initial setup procedure with each data dictionary specifying category, sub-category, name, and description of fields of the data source schema to aid embedding and semantic searching.

In addition, during the setup operation of the dynamic expanded context prompt generation engine 200, the query/request store engine 220 creates the query/request store 225. The query/request store 225 stores the particular query/request submitted to the LLM 290 and the particular fields of the data source schema required to generate the RAG prompt for processing the query/request. Thus, a mapping of query/request to particular fields is stored in the query/request store 225 to assist with identifying the initial fields for subsequent similar queries/responses. The query/request store 225 can be set up initially with input from subject matter experts. It builds over time as more queries/responses are processed via the dynamic expanded context prompt generation engine 200 and LLM 290. The data dictionaries for the data source schemas and the data in the query/response store 225 may be vectors of vector stores created by performing an embedding on all columns of data structures.

After setup, during runtime operation, a query/request processing engine 230 of the dynamic expanded context prompt generation engine 200 receives an input query/request from a client computing device 292-296, e.g., client computing device 292. For example, a user of a client computing device 292 may log onto the LLM 290 via a user interface and submit a question to the LLM 290, such as “what is the ESG score of IBM Corporation?” or the like. The query/request processing engine 230 performs natural language processing, such as encoding the query/request to embeddings to facilitate vector similarity search. The encoded user query/request is used by the initial field identification engine, in conjunction with the query/request store engine 220 to perform a semantic search in the query/request store 225 for any similar questions that have been stored from a previous processing of a previous query/request by the dynamic expanded context prompt generation engine 200. The semantic lookup determines a degree of matching of the entries in the query/request store 225 and if the degree of matching is equal or above a predetermined threshold, then the entry may be considered a match. A highest similarity match may then be selected and the corresponding fields used as the initial set of fields in the initial field listing.

If a matching entry is not found in the query/request store 225 by the initial field identification engine 240 and query/request store engine 220, the initial field identification engine 240 may utilize the encoded input query/request to semantically search the data dictionary for relevant fields based on field name and descriptions. These will be the initial fields for the initial field listing. Again, the determination of initial fields, as well as the additional fields as discussed hereafter, are based on encodings of the textual data of the input query/request and these fields and may be based on a vector similarity evaluation between vectors of encodings.

Once the initial fields are determined and compiled into the initial field list, the additional field identification and evaluation engine 250 dynamically augments this initial field listing based on a learned context. For example, in some illustrative embodiments, for each initial field F in the initial fields listing, its sibling and cousin fields in the data schema are scanned. For each of these sibling and cousin fields, the additional field identification and evaluation engine 250 determines a similarity with each of their corresponding initial fields in the initial field listing, e.g., determining a similarity between vector embeddings of the initial field name and description Fᵢ and the names/descriptions of the sibling/cousin fields (candidate fields) CFᵢ, where i is the index of the field in the initial field listing.

Each of the adjacent fields, i.e., sibling and cousin fields, are analyzed to determine candidate fields that are relevant to the initial fields in the initial fields listing. The relevant candidate fields may include all of the adjacent fields to the initial field or a subset of these adjacent fields that are determined to have sufficiently high relevance to the initial fields. The initial fields and the candidate fields have different data types, e.g., text, numeric, percentile, etc. and based on the data type, additional fields may be identified as more/less relevant. For example, fields with numeric types may have adjacent candidate fields that are “methodology” fields which indicate how the numeric value is obtained and/or what it represents, such that these candidate fields are of significant relevance. For fields have a “date” data type, candidate fields may be identified that indicate whether the date field indicates a creation/update date and thus, these candidate fields would be considered highly relevant. For other field data types, other types of candidate fields may be predetermined to be of high relevance to these fields in the logic of the additional field identification and evaluation engine 250, such as in a set of predetermined executable rules, such that the initial field list may be expanded with additional candidate fields that are determined to be relevant to the initial fields based on data types. Thus, by scanning the sibling and cousin fields (candidate fields) CFᵢ of an initial field Fi, and analyzing those fields to determine their similarity or relevance to the initial field Fi, the context for the processing of the input query/request may be expanded to include not only the initial fields Fᵢ, but the relevant candidate fields CFᵢ, which may be a subset of the candidate fields CFᵢ which is less than the total number of candidate fields CFᵢ.

The expanded field listing comprising the initial fields Fᵢ and the relevant candidate fields CFᵢ is input to the retrieval augmented generation (RAG) prompt generator 260 which generates a RAG prompt for input to the LLM 290 via the LLM interface 270. The RAG prompt that is generated by the RAG prompt generator 260 comprises a first portion that has a natural language query/request for the LLM engine corresponding to the initial query/request, and a second portion which is customized to the particular context comprising the data for the expanded field listing. Thus, when the LLM 290 operates on the RAG prompt, the LLM 290 will utilize this context to generate the answer/response to the query/request in the first portion of the RAG prompt.

The LLM 290 processes the RAG prompt comprising the expanded context determined by way of the above operations and generates a response to the input query/request in a manner generally known in the art. However, the response generated by the LLM 290 will be more accurate and useable to the submitter of the input query/request because the mechanisms of the illustrative embodiments have expanded the context beyond just the required fields, i.e., the initial field listing, to include additional candidate fields that are determined to be relevant to the initial fields. This adds additional context, but does not add all of the possible candidate fields which would cause the problems associated with the naïve expansion example discussed above where all adjacent fields are added to the context. As a result, an improved operation of the LLM 290 is accomplished that provides an efficient processing of input queries/responses that generates more accurate results with compact responses that do not require users to comb through large amounts of information in the response to find the relevant portions.

The LLM 290 returns the answer/response either directly to the original requesting client computing device, e.g., client 292, via the one or more data networks, or returns the answer/response to the dynamic expanded context prompt generation engine 200 which then forwards the answer/response to the client computing device 292. In either case, the operation of the dynamic expanded context prompt generation engine 200 may be not perceived by the users of the client computing devices 292-296 apart from a higher quality answer/response being provided in response to their initial queries/requests.

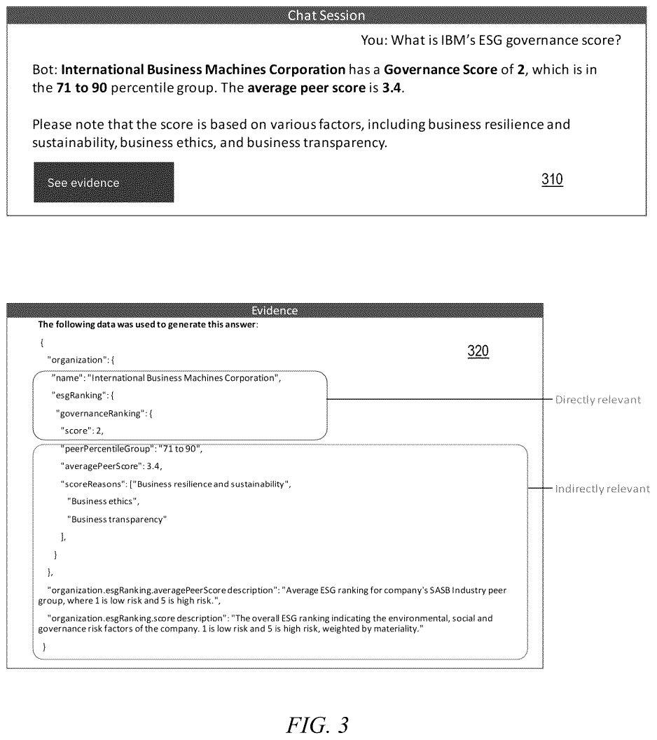

FIG. 3 is an example diagram illustrating an example of the data blocks used by an LLM to generate a response to an original input question in accordance with one illustrative embodiment. The upper portion 310 of the diagram illustrates the response generated by the LLM based on the operation of the illustrative embodiments. The lower portion 320 shows the way in which the LLM translated the original question, the database and corresponding data schema used, and the particular data blocks identified by the mechanisms of the illustrative embodiments. For example, as shown in FIG. 3, the illustrative embodiments encode the input question of “What is IBM's ESG governance score?” to understand the semantic meaning of the query/request. The illustrative embodiments identify the directly matching fields, or “required” fields, to answer the question, e.g., “organization.esgRanking.governanceRanking.score.” This is considered a directly relevant field and is added to the initial fields of the initial field listing. The illustrative embodiments further identify the sibling fields of “ . . . peerPercentileGroup”, “ . . . averagePeerScore”, “ . . . scoreReasons”, and “ . . . averagePeerScoreDescription” as additional relevant fields for inclusion in the expanded field listing. These fields are considered indirectly relevant fields and are then used to populate the context of the RAG prompt for submission to the LLM. Without the additional fields, the LLM response would be limited to score 2. With the additional fields, the user would understand what score 2 means in terms of peer percentile, average peer score, and the reasons for the score.

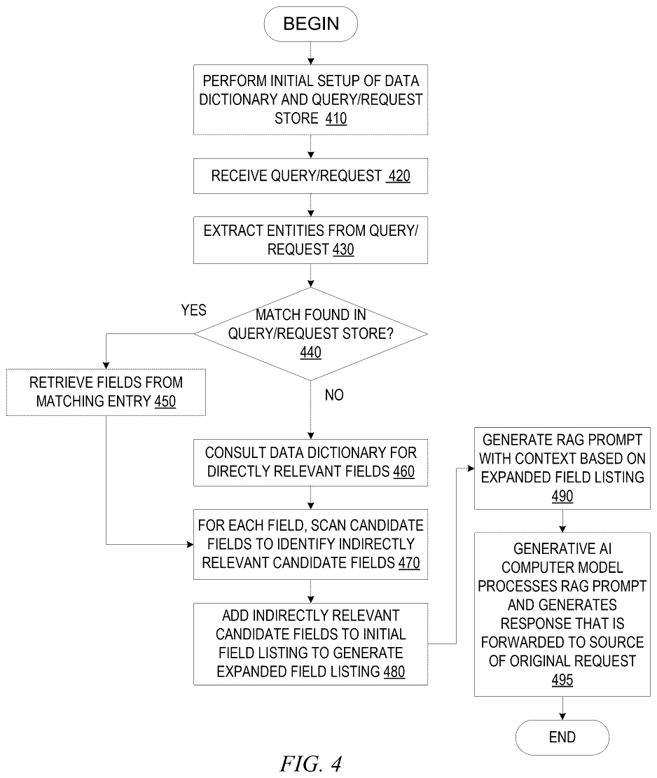

FIG. 4 is a flowchart outlining an example operation of generative artificial intelligence computer model based on an expanded context based prompt generated by a dynamic expanded contest prompt generation engine in accordance with one illustrative embodiment. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

As shown in FIG. 4, the operation starts by performing an initial setup of the data dictionary and query/request store (step 410). Thereafter, a query/request is received (step 420) and natural language processing of the query/request is performed to encode the query/request (step 430). A lookup of the entities in the query/request store is performed to determine if there are any matching entries (step 440). If there is a matching entry in the store, then the fields of that entry are used as an initial field listing (step 450). If there is not a matching entry in the store, then the data dictionary is consulted to identify the most relevant fields, to be the initial field listing (step 460).

After generating the initial field listing, for each field in the initial field listing, sibling and cousin fields (i.e., candidate fields) are scanned to determine which of these candidate fields are relevant to the corresponding initial field (step 470). The subset of relevant candidate fields are then added to the initial field listing to generate the expanded field listing (step 480). A RAG prompt is then generated based on the expanded field listing and submitted to a generative AI computer model, such as an LLM (step 490). The generative AI computer model processes the RAG prompt and generates an answer/response which is forwarded to the source of the original query/request (step 495). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving an input request from a client computing device;
identifying one or more first fields of a data dictionary of a data source schema for inclusion in an initial set of fields having direct matches to elements of the input request, to thereby generate an initial field listing;
for each first field in the initial field listing, analyzing second fields, adjacent to the one or more first fields, in the data dictionary, to identify a set of relevant second fields;
adding the set of relevant second fields to the initial field listing to generate an expanded field listing;
generating a prompt to a generative artificial intelligence (AI) computer model comprising a context portion populated with data for the first fields and relevant second fields in the expanded field listing; and
submitting the prompt to the generative AI computer model for processing, wherein the generative AI computer model processes the prompt and generates a response to the input request based on the context portion of the prompt.

2. The method of claim 1, wherein the set of relevant second fields comprises fewer fields than a total number of adjacent fields to the one or more first fields.

3. The method of claim 1, wherein identifying the one or more first fields comprises:
generating first embeddings associated with the fields of the data dictionary;
generating a second embedding of the input request; and
performing a similarity evaluation to generate similarity metrics quantifying a similarity between each first embedding and the second embedding, wherein in response to a similarity metric meeting a predetermined criterion, a corresponding field is identified to be a first field for generation of the initial field listing.

4. The method of claim 3, wherein analyzing second fields comprises performing a similarity evaluation between pairs of first embeddings associated with the adjacent fields to first embeddings associated with the one or more first fields in the initial field listing, wherein adjacent fields whose corresponding similarity metrics meet the predetermined criterion are selected as relevant second fields.

5. The method of claim 3, wherein the first embeddings are semantic embeddings generated based on one or more of a field name, a field category, a field sub-category, and a field description.

6. The method of claim 1, wherein a subset of the second fields are sibling fields to corresponding ones of the one or more first fields, wherein a sibling field is a field having a same category and sub-category as a corresponding first field.

7. The method of claim 1, wherein a subset of the second fields are cousin fields to corresponding ones of the one or more first fields, wherein a cousin field is a field having a same category, but different sub-category, as a corresponding first field.

8. The method of claim 1, wherein identifying one or more first fields comprises performing a similarity evaluation between a first embedding of the input request, and second embeddings associated with previous input requests to generate, for each second embedding, a similarity metric, wherein in response to a similarity metric associated with a second embedding meeting a predetermined criterion, relevant fields associated with a corresponding previous input request are retrieved as first fields for inclusion in the initial field listing.

9. The method of claim 1, wherein generating the prompt comprises inputting the expanded field listing into a retrieval augmented generation (RAG) prompt engine which generates a RAG prompt for input to the generative AI computer model.

10. The method of claim 1, wherein the generative AI computer model is a large language model (LLM) which receives the input request via a chatbot interface and outputs the response to the input request via the chatbot interface as a natural language response.

11. A computer program product comprising:
one or more computer-readable storage media; and
program instructions stored on the one or more computer-readable storage media to perform operations comprising:
receiving an input request from a client computing device;
identifying one or more first fields of a data dictionary of a data source schema for inclusion in an initial set of fields having direct matches to elements of the input request, to thereby generate an initial field listing;
for each first field in the initial field listing, analyzing second fields, adjacent to the one or more first fields, in the data dictionary, to identify a set of relevant second fields;
adding the set of relevant second fields to the initial field listing to generate an expanded field listing;
generating a prompt to a generative artificial intelligence (AI) computer model comprising a context portion populated with data for the first fields and relevant second fields in the expanded field listing; and
submitting the prompt to the generative AI computer model for processing, wherein the generative AI computer model processes the prompt and generates a response to the input request based on the context portion of the prompt.

12. The computer program product of claim 11, wherein the set of relevant second fields comprises fewer fields than a total number of adjacent fields to the one or more first fields.

13. The computer program product of claim 11, wherein identifying the one or more first fields comprises:
generating first embeddings associated with the fields of the data dictionary;
generating a second embedding of the input request; and
performing a similarity evaluation to generate similarity metrics quantifying a similarity between each first embedding and the second embedding, wherein in response to a similarity metric meeting a predetermined criterion, a corresponding field is identified to be a first field for generation of the initial field listing.

14. The computer program product of claim 13, wherein analyzing second fields comprises performing a similarity evaluation between pairs of first embeddings associated with the adjacent fields to first embeddings associated with the one or more first fields in the initial field listing, wherein adjacent fields whose corresponding similarity metrics meet the predetermined criterion are selected as relevant second fields.

15. The computer program product of claim 13, wherein the first embeddings are semantic embeddings generated based on one or more of a field name, a field category, a field sub-category, and a field description.

16. The computer program product of claim 11, wherein a subset of the second fields are sibling fields to corresponding ones of the one or more first fields, wherein a sibling field is a field having a same category and sub-category as a corresponding first field.

17. The computer program product of claim 11, wherein a subset of the second fields are cousin fields to corresponding ones of the one or more first fields, wherein a cousin field is a field having a same category, but different sub-category, as a corresponding first field.

18. The computer program product of claim 11, wherein identifying one or more first fields comprises performing a similarity evaluation between a first embedding of the input request, and second embeddings associated with previous input requests to generate, for each second embedding, a similarity metric, wherein in response to a similarity metric associated with a second embedding meeting a predetermined criterion, relevant fields associated with a corresponding previous input request are retrieved as first fields for inclusion in the initial field listing.

19. The computer program product of claim 11, wherein generating the prompt comprises inputting the expanded field listing into a retrieval augmented generation (RAG) prompt engine which generates a RAG prompt for input to the generative AI computer model.

20. A computer system comprising:
a processor set;
one or more computer-readable storage media; and
program instructions stored on the one or more computer-readable storage media to cause the processor set to perform operations comprising:
receiving an input request from a client computing device;
identifying one or more first fields of a data dictionary of a data source schema for inclusion in an initial set of fields having direct matches to elements of the input request, to thereby generate an initial field listing;
for each first field in the initial field listing, analyzing second fields, adjacent to the one or more first fields, in the data dictionary, to identify a set of relevant second fields;
adding the set of relevant second fields to the initial field listing to generate an expanded field listing;
generating a prompt to a generative artificial intelligence (AI) computer model comprising a context portion populated with data for the first fields and relevant second fields in the expanded field listing; and
submitting the prompt to the generative AI computer model for processing, wherein the generative AI computer model processes the prompt and generates a response to the input request based on the context portion of the prompt.
